(19) United States
(12) Patent Application Publication
(10) Pub. No.: US 2015/0268907 A1
(43) Pub. Date: Sep. 24, 2015

(54) IMAGE PROCESSING DEVICE AND NON-TRANSITORY COMPUTER READABLE MEDIUM

(71) Applicant: FUJI XEROX CO., LTD., Tokyo (JP)

(72) Inventor: Hiroyasu ISHIJIMA, Kanagawa (JP)

(73) Assignee: FUJI XEROX CO., LTD., Tokyo (JP)

(21) Appl. No.: 14/479,656

(22) Filed: Sep. 8, 2014

(30) Foreign Application Priority Data
Mar. 20, 2014 (JP) 2014-057817

(51) Int. Cl. G06F 3/12

(52) U.S. Cl. CPC G06F 3/1247; G06F 3/122; G06F 3/1267

(57) ABSTRACT

An image processing device includes a rendering unit and a controller. The rendering unit includes a storage unit that stores therein an image transferred with transfer information when the rendering unit receives the transfer information and renders a print image. The rendering unit renders the print image while using the image stored in the storage unit. The controller includes a converting unit that converts information to be output into the transfer information and transfers the transfer information to the rendering unit. The converting unit manages a storage status of the storage unit included in the rendering unit and controls use of the storage unit by the rendering unit based on the transfer information.

### CROSS-REFERENCE TO RELATED APPLICATIONS

This application is based on and claims priority under 35 USC 119 from Japanese Patent Application No. 2014-057817 filed Mar. 20, 2014.

### BACKGROUND

### Technical Field

The present invention relates to image processing devices and non-transitory computer readable media.

### SUMMARY

According to an aspect of the invention, there is provided an image processing device including a rendering unit and a controller. The rendering unit includes a storage unit that stores therein an image transferred with transfer information when the rendering unit receives the transfer information and renders a print image. The rendering unit renders the print image while using the image stored in the storage unit. The controller includes a converting unit that converts information to be output into the transfer information and transfers the transfer information to the rendering unit. The converting unit manages a storage status of the storage unit included in the rendering unit and controls use of the storage unit by the rendering unit based on the transfer information.

### BRIEF DESCRIPTION OF THE DRAWINGS

Exemplary embodiments of the present invention will be described in detail based on the following figures, wherein:

FIG. 1 illustrates the configuration of an image processing device according to an exemplary embodiment of the present invention;

FIG. 2 illustrates a first specific example of an image processing device according to an exemplary embodiment of the present invention;

FIGS. 3A to 3C illustrate examples of an identifier management table and an image management table;

FIG. 4 illustrates the flow of operation performed by a converting unit in the first specific example of the image processing device according to the exemplary embodiment of the present invention;

FIG. 5 illustrates the flow of operation performed by a rendering unit in the first specific example of the image processing device according to the exemplary embodiment of the present invention;

FIG. 6 illustrates a second specific example of an image processing device according to an exemplary embodiment of the present invention;

FIGS. 7A and 7B illustrate the flow of operation performed by the converting unit in the second specific example of the image processing device according to the exemplary embodiment of the present invention;

FIG. 8 illustrates a third specific example of an image processing device according to an exemplary embodiment of the present invention;

FIGS. 9A and 9B illustrate the flow of operation performed by the converting unit in the third specific example of the image processing device according to the exemplary embodiment of the present invention;

FIGS. 10A and 10B illustrate a fourth specific example of an image processing device according to an exemplary embodiment of the present invention;

FIGS. 11A to 11C illustrate the flow of operation performed by the converting unit in the fourth specific example of the image processing device according to the exemplary embodiment of the present invention;

FIG. 12 illustrates a fifth specific example of an image processing device according to an exemplary embodiment of the present invention;

FIG. 13 illustrates the configuration of an image forming apparatus according to an exemplary embodiment of the present invention; and

FIG. 14 illustrates a computer program, a storage medium having the computer program stored therein, and a computer when the functions of the converting unit and the rendering unit described in the image processing device according to an exemplary embodiment of the present invention are realized by the computer program.

### DETAILED DESCRIPTION

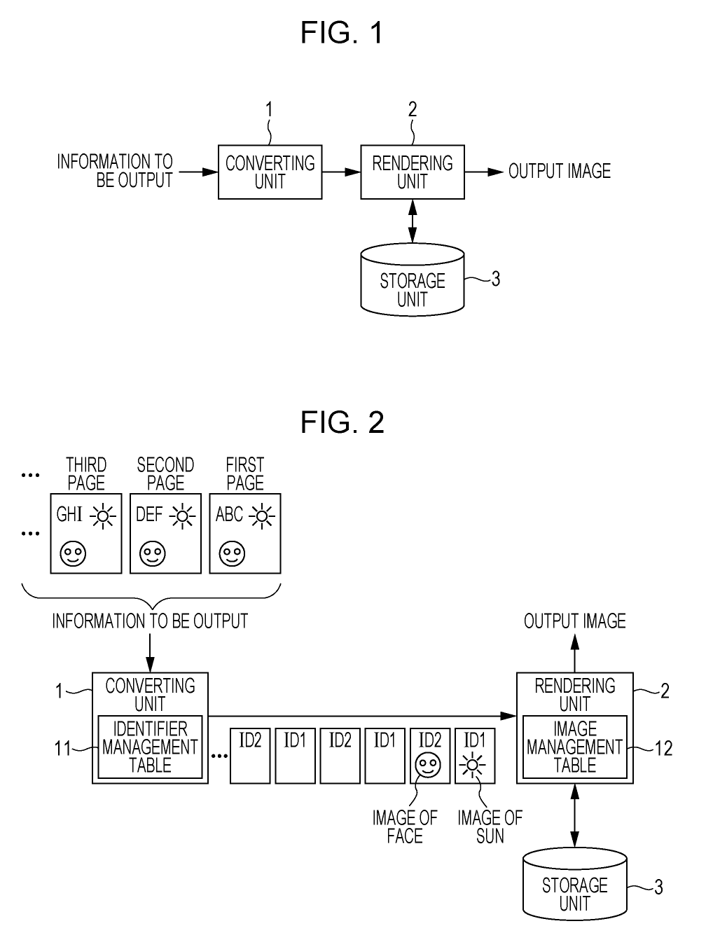

FIG. 1 illustrates the configuration of an image processing device according to an exemplary embodiment of the present invention. In FIG. 1, reference numeral 1 denotes a converting unit, 2 denotes a rendering unit, and 3 denotes a storage unit. In the configuration shown in FIG. 1, the converting unit 1 receives information to be output, converts the information into transfer information, and transfers the transfer information to the rendering unit 2. The rendering unit 2 receives the transfer information from the converting unit 1 and performs a rendering process in accordance with the transfer information. The converting process in the converting unit 1 and the rendering process in the rendering unit 2 are performed asynchronously. Although the transfer information is transferred from the converting unit 1 to the rendering unit 2, information is not transmitted from the rendering unit 2 to the converting unit 1.

When rendering an image (print image) after receiving the transfer information from the converting unit 1, the rendering unit 2 has a function for storing the image transferred with the transfer information into the storage unit 3 and performing the rendering process while using the image.

The converting unit 1 manages the storage status of the storage unit 3 used by the rendering unit 2 and performs control for determining whether or not to include the image in the transfer information when the converting unit 1 performs the converting process on the transfer information with respect to the image. For example, if a certain image included in transfer information is transferred to the rendering unit 2 and is stored into the storage unit 3 by the rendering unit 2, the image is not to be included in subsequent transfer information and the rendering unit 2 is made to use the image stored in the storage unit 3. In this case, the amount of data in the transfer information is reduced by an amount equivalent to the non-included image. Even if the image is to be used multiple times, the image is included in the transfer information only the first time. Furthermore, since information is not received from the rendering unit 2 and the storage unit 3, communication paths therefor are not necessary, and the processes in the converting unit 1 and the rendering unit 2 are performed asynchronously.

Furthermore, by comparing the data amount of the transferred image included in the transfer information with a preset capacity of the storage unit 3, the remaining capacity of the storage unit 3 is determined. Based on this comparison result, if a new image stored into the storage unit 3 by the rendering unit 2 causes the storage unit 3 to overflow, transfer information is transferred such that the rendering unit 2 does not store the transferred image included in the transfer information into the storage unit 3. Alternatively, control may be performed such that transfer information that commands deletion of the image stored in the storage unit 3 is transferred to the rendering unit 2 so as to ensure enough capacity in the storage unit 3.

Furthermore, when processing multiple pages worth of information to be output, an image may be commonly used among the pages, or if the same format is repeatedly used in units of multiple pages, an image may be repeatedly used in these units. Although such an image may be reused by being stored in the storage unit 3, if different images are used or if a replaced image is used, for example, it is better not to use the storage unit 3. For example, control may be performed such that the above-described process is performed for pages set in advance, and an image excluding the image stored in the storage unit 3 is included in the transfer information and is not to be stored into the storage unit 3.

Several examples will be described below. FIG. 2 illustrates a first specific example of an image processing device according to an exemplary embodiment of the present invention. In FIG. 2, reference numeral 11 denotes an identifier management table, and 12 denotes an image management table. In this first specific example, when the converting unit 1 transfers transfer information with images included therein, the converting unit 1 transfers the transfer information having different identifiers added to different images to the rendering unit 2. After transferring the transfer information with the images included therein, redundant images are not to be included in the transfer information, but identifiers for such images are transferred. When the rendering unit 2 detects an identifier, if an image is included, the rendering unit 2 stores the image into the storage unit 3 in correspondence with the identifier. If an identifier is detected but an image is not included, the rendering unit 2 searches through the storage unit 3 based on the identifier, reads an image corresponding to the identifier from the storage unit 3, and performs a rendering process by using the read image.

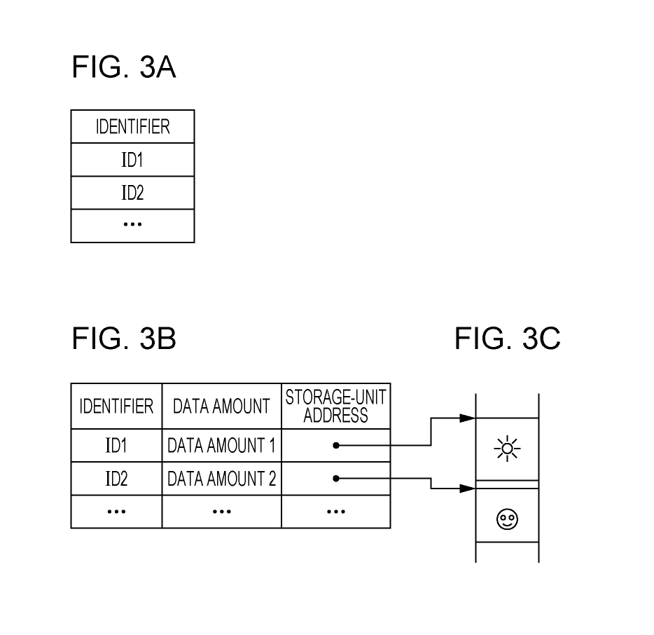

When performing such operation, the converting unit 1 may use the identifier management table 11, and the rendering unit 2 may use the image management table 12. FIGS. 3A to 3C illustrate examples of the identifier management table 11 and the image management table 12. FIG. 3A illustrates an example of the identifier management table 11 managed by the converting unit 1. In the identifier management table 11 shown in FIG. 3A, identifiers added to images are registered and are managed by the converting unit 1. When the converting unit 1 transfers transfer information with an image included therein and an identifier added thereto to the rendering unit 2, the converting unit 1 registers the identifier added to the transfer information into the identifier management table 11. The image corresponding to the identifier registered in the identifier management table 11 is assumed to be stored into the storage unit 3 by the rendering unit 2. Thus, this image is not to be transferred thereafter. Therefore, the identifier is transferred to the rendering unit 2 as transfer information without the image included therein. The identifier management table 11 shown in FIG. 3A is only an example, and other various kinds of information, such as the image size, may be added thereto.

FIG. 3B illustrates an example of the image management table 12 managed by the rendering unit 2. In the example of the image management table 12 shown in FIG. 3B, an identifier, a data amount as information of the image corresponding to the identifier, and an address at which the image is stored in the storage unit 3 are registered. When an image with an identifier added thereto as transfer information is transferred from the converting unit 1, the rendering unit 2 stores the image into the storage unit 3 and registers an address indicating the storage destination and the data amount of the image into the image management table 12 in correspondence with the added identifier. FIG. 3C illustrates the state of the storage unit 3 having the image stored therein. If an identifier is transmitted but an image is not included, the rendering unit 2 searches through the image management table 12 based on the transmitted identifier, acquires the corresponding address and the corresponding data amount, reads an image from the storage unit 3 based on the acquired address and the acquired data amount, and uses the image for a rendering process. With regard to the example of the image management table 12 shown in FIG. 3B, other various kinds of information may be added thereto.

For example, in the example shown in FIG. 2, an image of the sun and an image of a face are disposed in each page of information to be output. The image of the sun has an identifier ID1 added thereto, and the image of the face has an identifier ID2 added thereto. Such information to be output is converted into transfer information by the converting unit 1 and is transferred therefrom. When transferring the image of the sun on the first page, since the transferring of this image is performed for the first time, the identifier ID1 for the image of the sun is not registered in the identifier management table 11 yet. In this case, the image of the sun is included in the transfer information and has the identifier ID1 added thereto before being transferred from the converting unit 1 to the rendering unit 2. In addition, the identifier ID1 is registered into the identifier management table 11. The rendering unit 2 receives the identifier ID1 together with the image of the sun, stores the image of the sun into the storage unit 3, and registers the identifier ID1, the data amount of the image of the sun, and the address stored in the storage unit 3 into the image management table 12 in correspondence with one another.

With regard to the image of the face on the first page, the identifier ID2 for the image of the face is also not registered in the identifier management table 11 yet. Therefore, the image of the face is included in the transfer information and has the identifier ID2 added thereto before being transferred from the converting unit 1 to the rendering unit 2. In addition, the identifier ID2 is registered into the identifier management table 11. The rendering unit 2 receives the image of the face together with the identifier ID2, stores the image of the face into the storage unit 3, and registers the identifier ID2, the data amount of the image of the face, and the address stored in the storage unit 3 into the image management table 12 in correspondence with one another.

With regard to the image of the sun on the second page, since the image of the sun on the first page has already been transferred, the identifier ID1 for the image of the sun is registered in the identifier management table 11. Therefore, the transfer information is transferred with the identifier ID1 added thereto but without the image of the sun included therein. Although the rendering unit 2 receives the identifier ID1, since an image is not included, the rendering unit 2 searches for the received identifier ID1 through the image management table 12. By performing this search, the data amount and the address corresponding to the identifier ID1 are acquired from the registered information. Based on the address and the data amount, the rendering unit 2 reads the image of the sun from the storage unit 3 and uses the read image for a rendering process.

With regard to the image of the face on the second page, since the image of the face on the first page has already been transferred, the identifier ID2 for the image of the face is registered in the identifier management table 11. Therefore, the transfer information is transferred with the identifier ID2 added thereto but without the image of the face included therein. Although the rendering unit 2 receives the identifier ID2, since an image is not included, the rendering unit 2 searches for the received identifier ID2 through the image management table 12. By performing this search, the data amount and the address corresponding to the identifier ID2 are acquired from the registered information. Based on the address and the data amount, the rendering unit 2 reads the image of the face from the storage unit 3 and uses the read image for a rendering process.

Subsequently, with regard to the image of the sun and the image of the face, identifiers therefor are transferred without including the images in the transfer information. Since images that are repeatedly used are not transferred for the second time and onward, the transferring time and the data amount may be reduced, as compared with the related art in which an image is transferred every time.

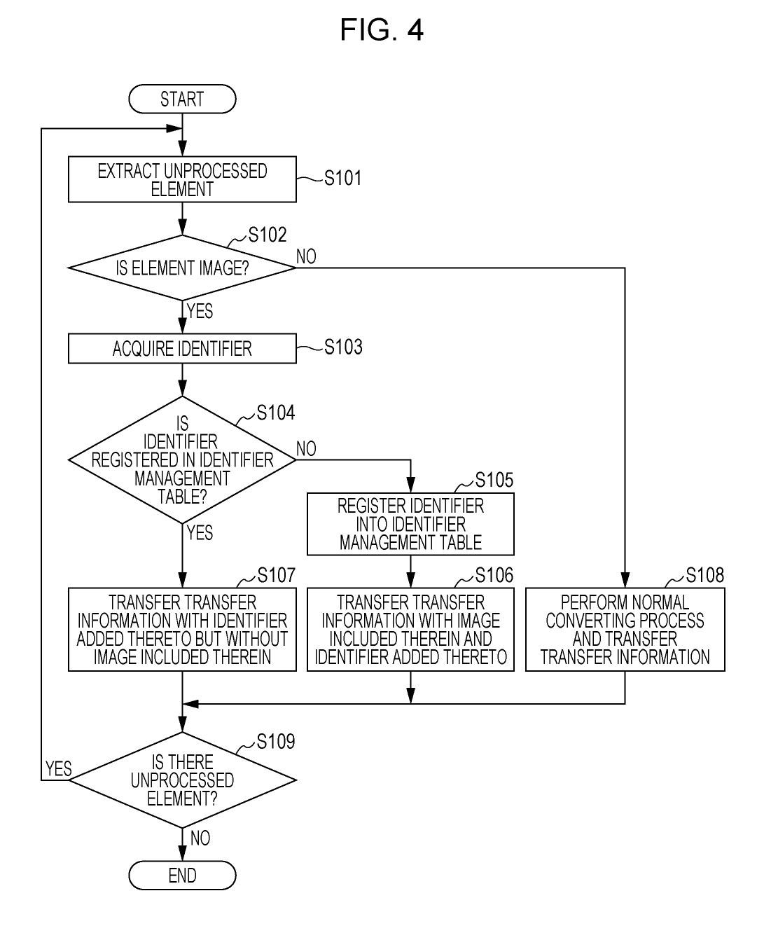

FIG. 4 illustrates the flow of operation performed by the converting unit 1 in the first specific example of the image processing device according to the exemplary embodiment of the present invention. In step S101, an unprocessed element is extracted from information to be output. In step S102, it is determined whether or not the element is an image. If the element is an image, an identifier for the image is acquired in step S103. For example, information for identifying the image within the information to be output may be used as the identifier, or the identifier may be generated from the information for identifying the image. In a set of information to be output, identifiers are unique.

In step S104, it is determined whether or not the identifier acquired in step S103 is registered in the identifier management table 11. If the identifier is not registered in the identifier management table 11, the identifier is registered into the identifier management table 11 in step S105. In step S106, transfer information with the image included therein and the identifier added thereto is transferred to the rendering unit 2. If it is determined in step S104 that the identifier is registered in the identifier management table 11, transfer information with the identifier added thereto but without the image included therein is transferred to the rendering unit 2 in step S107. With regard to an element determined not to be an image in step S102, the element undergoes a converting process according to the type thereof, and transfer information is transferred to the rendering unit 2 in step S108.

In step S109, it is determined whether or not there is an unprocessed element. If there is an unprocessed element, the operation returns to step S101 so as to process the element. When there is no unprocessed element remaining, the converting process for the set of information to be output ends.

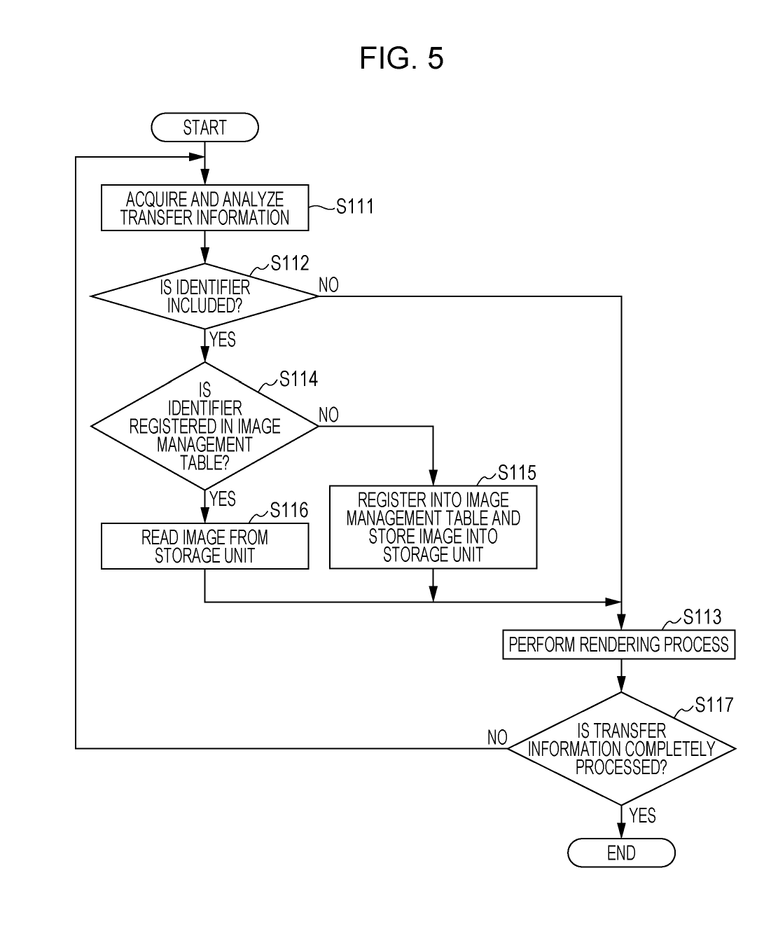

FIG. 5 illustrates the flow of operation performed by the rendering unit 2 in the first specific example of the image processing device according to the exemplary embodiment of the present invention. In step S111, the rendering unit 2 analyzes transfer information transferred from the converting unit 1. In step S112, it is determined whether or not the transfer information includes an identifier. If an identifier is not included, the rendering unit 2 performs a normal rendering process in step S113. This rendering process includes an image rendering process. For an image not having an identifier added thereto, the operation proceeds from step S112 to step S113 where the rendering unit 2 performs a rendering process. Furthermore, every time an end command of each page is indicated by the transfer information, the previously rendered image corresponding to one page is output as an output image.

If it is determined in step S112 that an identifier is included, it is determined in step S114 whether or not the identifier is registered in the image management table 12. If the identifier is not registered in the image management table 12, the rendering unit 2 renders the image included in the transfer information, stores a copy of the image into the storage unit 3, and registers the address and the data amount of the image into the image management table 12 in correspondence with the identifier in step S115. The operation then proceeds to step S113 where the rendering unit 2 performs an image rendering process.

If it is determined in step S114 that the identifier is registered in the image management table 12, the rendering unit 2 reads an image from the storage unit 3 based on the address and the data amount registered in the image management table 12 in correspondence with the identifier in step S116. Then, in step S113, the rendering unit 2 performs a rendering process by using the image read from the storage unit 3. In this case, since the image within the transfer information has already been deployed when the image is stored into the storage unit 3, the image is used for the rendering process without having to perform a deployment process.

In step S117, it is determined whether or not the transfer information is completely processed. If there is unprocessed transfer information remaining, the operation returns to step S111 so as to repeat a rendering process for the unprocessed transfer information. When the transfer information is completely processed, the rendering process ends.

With regard to a set of information to be output, when the rendering process by the rendering unit 2 ends and the output images are output, the converting unit 1 deletes the identifiers registered in the identifier management table 11 and the rendering unit 2 deletes the images stored in the storage unit 3 as well as registered contents in the image management table 12 so as to prepare for processing of new information to be output. With regard to a commonly-used image, a function for not deleting such an image from the identifier management table 11, the image management table 12, and the storage unit 3 may be provided.

Although the process performed by the converting unit 1 shown in FIG. 4 and the process performed by the rendering unit 2 shown in FIG. 5 are performed asynchronously, the converting unit 1 manages the storage unit 3 without having to transmit information from the rendering unit 2 to the converting unit 1 or without having to directly access the storage unit 3.

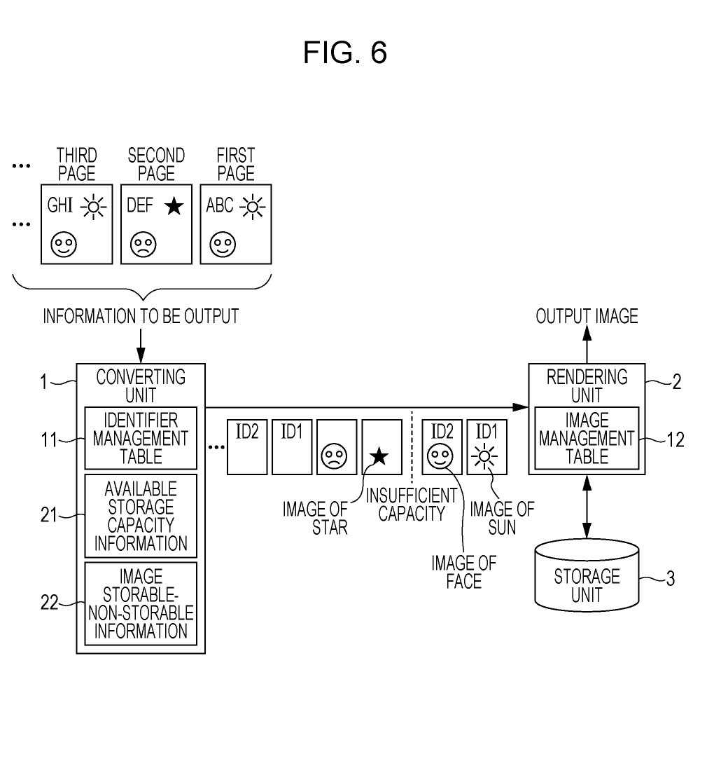

FIG. 6 illustrates a second specific example of an image processing device according to an exemplary embodiment of the present invention. In FIG. 6, reference numeral 21 denotes available storage capacity information and 22 denotes image storable-non-storable information. Although already mentioned above, the converting unit 1 and the rendering unit 2 operate asynchronously. The converting unit 1 converts information to be output into transfer information and transfers the transfer information to the rendering unit 2. The rendering unit 2 receives the transfer information and performs a rendering process. Although the rendering unit 2 makes the storage unit 3 store an image included in the transfer information in the process according to the first specific example, the image is sometimes not storable in the storage unit 3 depending on the available capacity in the storage unit 3. When this occurs, the converting unit 1 has already proceeded with a subsequent process, causing a discrepancy to occur between the identifier management table 11 managed by the converting unit 1 and the image management table 12 managed by the rendering unit 2. If transfer information with an identifier added thereto but without an image included therein is continuously transferred from the converting unit 1, a problem, such as a missing image, may occur since an image that should be rendered does not exist. For example, even if an error message indicating that an image is non-storable is transmitted from the rendering unit 2 to the converting unit 1, the converting unit 1 has to perform reprocessing at that point by tracing back to the already-transferred transfer information, and moreover, a communication path for transmitting such an error notification becomes necessary. In this second specific example, the capacity of the storage unit 3 is managed by the converting unit 1 so as to cope with insufficient capacity.

As a configuration that copes with insufficient capacity of the storage unit 3, the converting unit 1 uses the available storage capacity information 21 and the image storable-non-storable information 22 in the second specific example shown in FIG. 6. In the available storage capacity information 21, the storage capacity of the storage unit 3 is set as an initial value. When transfer information with an image included therein and an identifier added thereto is transferred, the identifier is registered into the identifier management table 11, the data amount of the transferred image is sequentially subtracted, and the available capacity in the storage unit 3 is indicated. If this available storage capacity information 21 becomes smaller than or equal to the data amount of the image to be transferred, transferring of this image may cause an error to occur in the rendering unit 2 due to insufficient available capacity. In this case, the image is included in the transfer information but is transferred to the rendering unit 2 without having an identifier added thereto. Since an identifier is not added, the rendering unit 2 performs a normal process on the transfer information regardless of image rendering. For example, in the example of the process performed by the rendering unit 2 shown in FIG. 5, the operation proceeds from step S112 to step S113 where the rendering unit 2 performs a rendering process on the image included in the transfer information. In this case, an identifier is not added, and the image is not stored into the storage unit 3, so that an error caused by insufficient capacity does not occur.

The image storable-non-storable information 22 indicates whether or not an image may be transferred by comparing the available storage capacity information 21 with the data amount of the image to be transferred. The image storable-non-storable information 22 is used when switching the process performed by the converting unit 1. A configuration not provided with this information is also permissible.

For example, in the example shown in FIG. 6, transfer information is transferred with an image of the sun included therein and an identifier ID1 added thereto. Furthermore, transfer information is transferred with an image of a face included therein and an identifier ID2 added thereto. The converting unit 1 subtracts the data amount of the image of the sun and the data amount of the image of the face from the capacity of the storage unit 3 and stores the capacity as the available storage capacity information 21. The image of the sun and the image of the face are stored into the storage unit 3 by the rendering unit 2.

Subsequently, when an image of a star is to be transferred, it is assumed that, after comparing the available storage capacity information 21 with the data amount of the image of the star, the available capacity in the storage unit 3 contained in the available storage capacity information 21 is smaller than the data amount of the image of the star. In this case, if transfer information is to be transferred with the image of the star included therein and, for example, an identifier ID3 added thereto, the rendering unit 2 tries to store the image of the star into the storage unit 3, resulting in an error. In the second specific example, in order to avoid such an error, transfer information with the image of the star included therein but without an identifier added thereto is transferred to the rendering unit 2. Since an identifier is not added, the rendering unit 2 performs a normal rendering process so as to render the image of the star included in the transfer information. In this case, the image of the star is not stored into the storage unit 3 so that an error does not occur. Accordingly, the storage unit 3 used by the rendering unit 2 is managed by the converting unit 1.

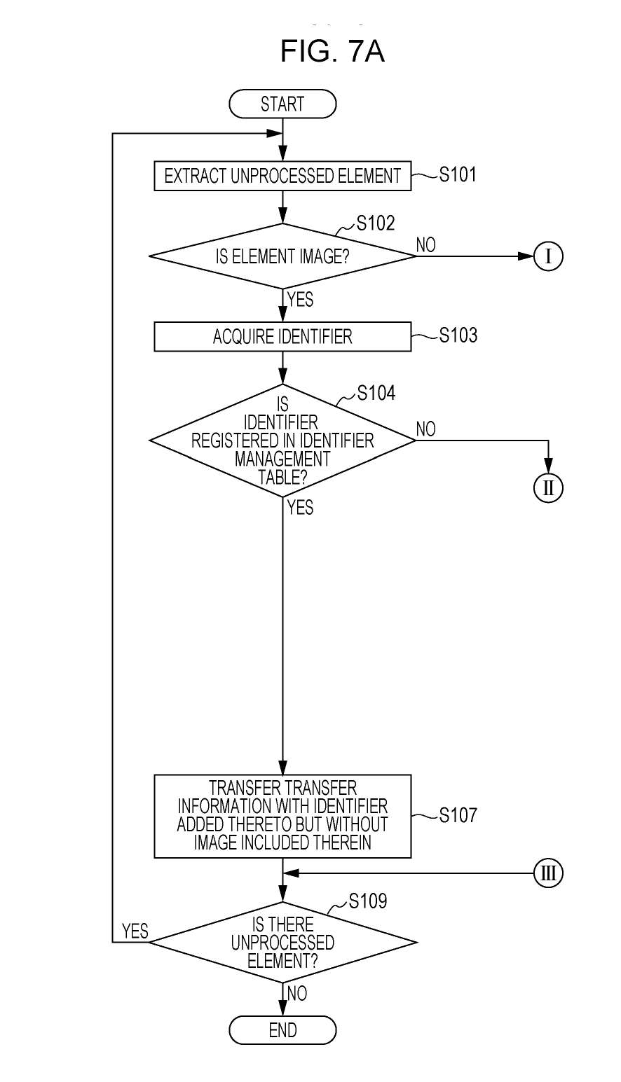

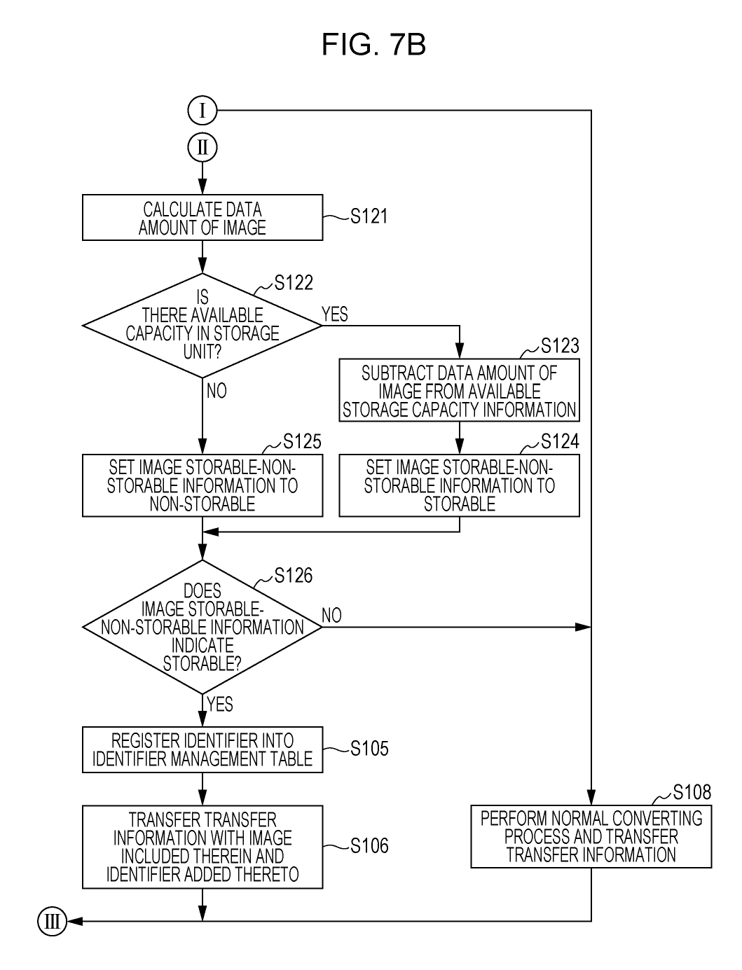

FIGS. 7A and 7B illustrate the flow of operation performed by the converting unit 1 in the second specific example of the image processing device according to the exemplary embodiment of the present invention. The following description relates to an example of operation in which the available capacity in the storage unit 3 is managed in addition to the function of the first specific example described above. With regard to the process described above with reference to FIG. 4 in the first specific example, reference characters shown in FIG. 4 are directly used, and descriptions of redundant processes may sometimes be omitted. In the available storage capacity information 21, the capacity of the storage unit 3 is set as an initial value.

In step S101, an unprocessed element is extracted from information to be output. In step S102, it is determined whether or not the element is an image. If the element is an image, an identifier for the image is acquired in step S103. In step S104, it is determined whether or not the identifier is registered in the identifier management table 11. If it is determined in step S104 that the identifier is registered in the identifier management table 11, transfer information with the identifier added thereto but without the image included therein is transferred to the rendering unit 2 in step S107.

If it is determined in step S104 that the identifier is not registered in the identifier management table 11, the data amount of the image is calculated in step S121. For example, the data amount of the image when deployed by the rendering unit 2 may be calculated from the width and the height of the image, the number of bits per pixel, and so on.

In step S122, it is determined whether or not there is available capacity in the storage unit 3 for storing the image therein by comparing the data amount of the image calculated in step S121 with the available storage capacity information 21. If it is determined that there is available capacity, the data amount of the image calculated in step S121 is subtracted from the available storage capacity information 21 in step S123 so as to obtain new available storage capacity information 21. In step S124, the image storable-non-storable information 22 is set to “storable”.

If it is determined in step S122 that there is no available capacity in the storage unit 3 for storing the image, the image storable-non-storable information 22 is set to “non-storable” in step S125 in this example.

In step S126, it is determined whether the image storable-non-storable information 22 indicates “storable” or “non-storable”. If “storable”, step S105 and onward described in the first specific example are performed. To describe this briefly, the identifier is registered into the identifier management table 11 in step S105, and transfer information with the image included therein and the identifier added thereto is transferred to the rendering unit 2 in step S106.

If the determination result in step S126 indicates that the image storable-non-storable information 22 indicates “non-storable”, this implies that there is no available capacity in the storage unit 3 for storing the image. Therefore, transfer information is transferred to the rendering unit 2 such that the image is not stored into the storage unit 3. In step S108, transfer information is generated by performing a normal converting process and is transferred to the rendering unit 2 together with an element determined not to be an image in step S102. If the element is an image, transfer information with the image included therein but without the identifier added thereto is transferred to the rendering unit 2. In this case, the identifier is not registered into the identifier management table 11.

In step S109, it is determined whether or not there is an unprocessed element. If there is an unprocessed element, the operation returns to step S101 so as to process the element. When there is no unprocessed element remaining, the converting process for the set of information to be output ends.

The process performed by the rendering unit 2 is the same as that described in the first specific example with reference to FIG. 5, and therefore, a description thereof will be omitted here. For example, in the above-described example of operation performed by the converting unit 1 shown in FIGS. 7A and 7B, if it is determined in step S122 that there is no available capacity in the storage unit 3 for storing an image, an image without an identifier is transferred in step S108. Therefore, a normal rendering process is performed in step S113 in FIG. 5 so as to render the transferred image. In this case, the image is not stored into the storage unit 3 so that the storage unit 3 is prevented from overflowing.

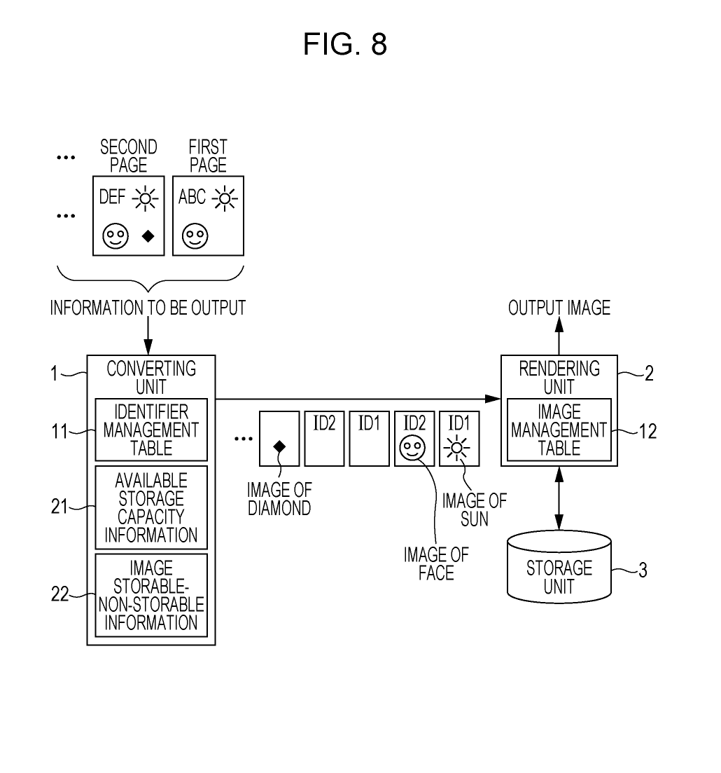

FIG. 8 illustrates a third specific example of an image processing device according to an exemplary embodiment of the present invention. As described above, when transfer information is transferred with an identifier added thereto but without an image included therein, the rendering unit 2 searches through the image management table 12 and reads an image from the storage unit 3. Although these searching and reading processes take some time, the time taken for these processes may sometimes be longer than the time taken for transferring an image. For example, if the data amount of an image is smaller than a certain value, the time taken for searching through the image management table 12 and for reading the image from the storage unit 3 may sometimes be longer than the time taken for transferring the image. In such a case, it is more desirable in view of the overall system to transfer the transfer information with an image included therein but without an identifier added thereto and to make the rendering unit 2 perform a normal image rending process rather than to transfer the transfer information with an identifier added thereto but without an image included therein as described in the first specific example.

The third specific example copes with the above-described case. A condition for determining what kind of image is more suited for transferring transfer information with an image included therein than causing the rendering unit 2 to search through the image management table 12 and to perform an image reading process is set in advance. Based on this condition, it is determined whether it is better to transfer an image or to use an identifier.

The condition used for the determination may be set by taking into account, for example, the time it takes to transfer the transfer information with the image included therein and the time it takes for the rendering unit 2 to search through the image management table 12 and to read the image from the storage unit 3. For example, the condition may be a threshold value for the data amount of the image. Alternatively, a different condition may be used. In addition to a fixed condition, a variable condition that changes in accordance with, for example, the number of registers in the image management table 12 may be used.

For example, in the example shown in FIG. 8, with regard to an image of the sun and an image of a face, each image is included in transfer information the first time and has an identifier added thereto before being transferred, as described in the first specific example. For the second time and onward, transfer information is transferred with the identifier added thereto but without the image included therein. With regard to an image of a diamond, for example, the data amount thereof may sometimes be smaller than the threshold value given as the preset condition. In this case, transfer information with the image of the diamond included therein but without an identifier added thereto is transferred to the rendering unit 2. The rendering unit 2 performs a normal image rendering process and does not perform a registration process on the image management table 12 or a storing process on the storage unit 3. With regard to the image of the diamond, transfer information with the image included therein but without the identifier added thereto is transferred to the rendering unit 2 for the second time and onward. Therefore, processes, such as searching through the image management table 12 and reading the image from the storage unit 3, are not performed.

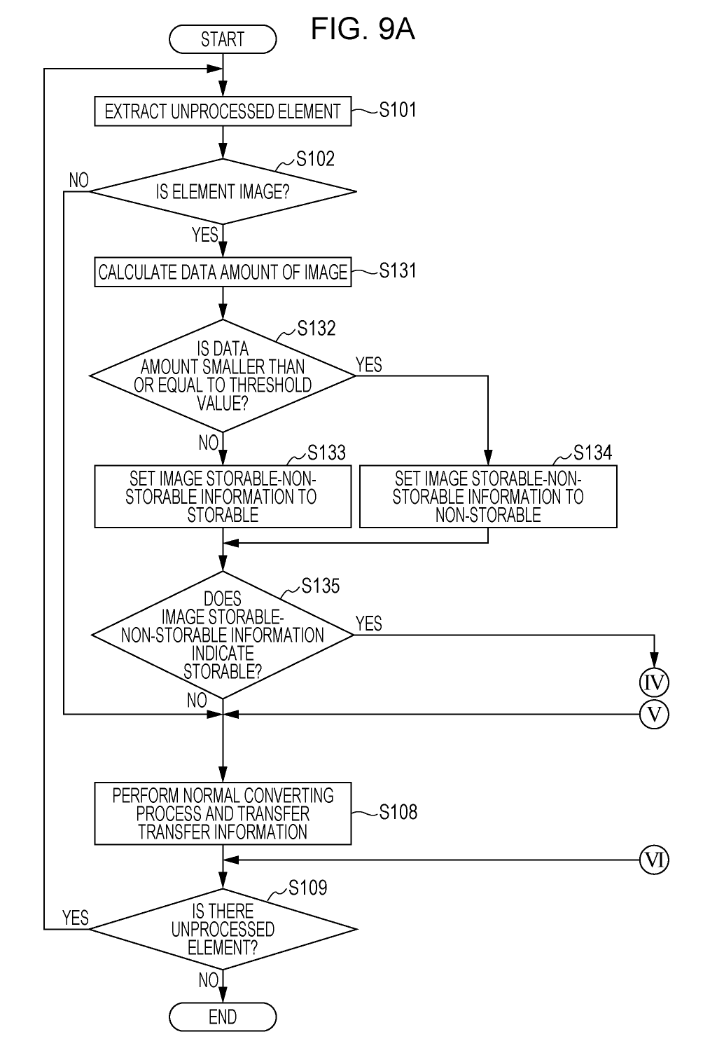

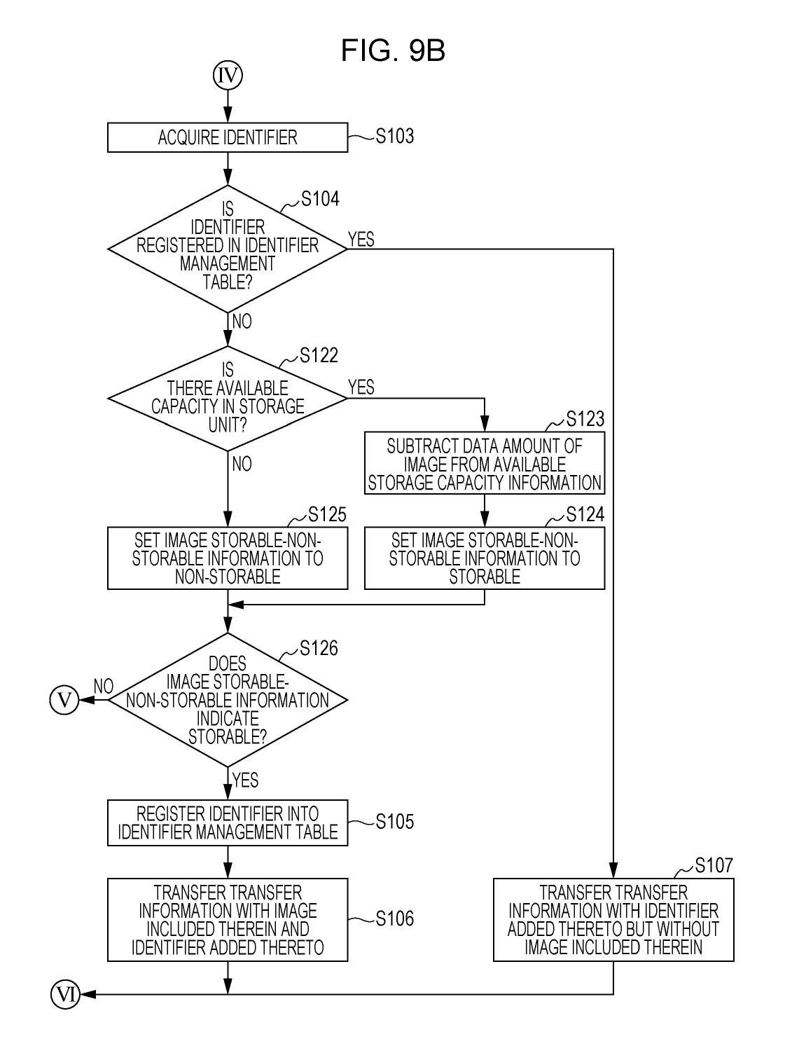

FIGS. 9A and 9B illustrate the flow of operation performed by the converting unit 1 in the third specific example of the image processing device according to the exemplary embodiment of the present invention. The following description relates to an example of operation in which control for determining whether or not to include an image in accordance with a preset condition is performed in addition to the functions of the first specific example and the second specific example described above. With regard to the process described above with reference to FIG. 4 in the first specific example and the process described with reference to FIGS. 7A and 7B in the second specific example, reference characters shown in FIGS. 4 and 7 are directly used, and descriptions of redundant processes may sometimes be omitted. As a condition for determining whether or not to include an image in transfer information, the data amount is used here. Thus, it is determined whether the data amount is larger than the threshold value or is smaller than or equal to the threshold value. The threshold value in this case is set in advance.

In step S101, an unprocessed element is extracted from information to be output. In step S102, it is determined whether or not the element is an image. If the element is an image, the data amount of the image is calculated in step S131. For example, the data amount of the image when deployed by the rendering unit 2 may be calculated from the width and the height of the image, the number of bits per pixel, and so on.

In step S132, it is determined whether the data amount calculated in step S131 satisfies the condition. In this case, it is determined whether or not the data amount is larger than the threshold value by comparing the data amount with the preset threshold value. If the data amount is larger than the threshold value, the image storable-non-storable information 22 is set to “storable” in step S133. If the data amount is smaller than or equal to the threshold value, the image storable-non-storable information 22 is set to “non-storable” in step S134.

In step S135, it is determined whether the image storable-non-storable information 22 indicates “storable” or “non-storable”. If “non-storable”, control is performed for not allowing the rendering unit 2 to perform a process using the storage unit 3. Specifically, transfer information with the image included therein but without an identifier added thereto is transferred to the rendering unit 2. In this example, in step S108, transfer information is generated by performing a normal converting process and is transferred to the rendering unit 2 together with an element determined not to be an image in step S102. In step S108, if the element is an image, transfer information with the image included therein but without the identifier added thereto is transferred to the rendering unit 2. In this case, the identifier is not registered into the identifier management table 11.

If it is determined in step S135 that the image storable-non-storable information 22 indicates “storable”, steps S103 and onward in FIGS. 7A and 7B are performed. To describe this briefly, the identifier for the image is acquired in step S103, and it is determined in step S104 whether or not the identifier is registered in the identifier management table 11. If it is determined in step S104 that the identifier is registered in the identifier management table 11, the operation proceeds to step S107 where transfer information with the identifier added thereto but without the image included therein is transferred to the rendering unit 2.

If it is determined in step S104 that the identifier is not registered in the identifier management table 11, the operation proceeds to step S122 where it is determined whether or not there is available capacity in the storage unit 3 for storing the image by comparing the data amount of the image calculated in step S131 with the available storage capacity information 21. If there is available capacity, the data amount of the image calculated in step S121 is subtracted from the available storage capacity information 21 in step S123 so as to obtain new available storage capacity information 21. In step S124, the image storable-non-storable information 22 is set to “storable”. If there is no available capacity, the image storable-non-storable information 22 is set to “non-storable” in step S125. In step S126, it is determined whether the image storable-non-storable information 22 indicates “storable” or “non-storable”. If the image storable-non-storable information 22 indicates “storable”, the identifier is registered into the identifier management table 11 in step S105, and transfer information with the image included therein and the identifier added thereto is transferred to the rendering unit 2 in step S106. If the image storable-non-storable information 22 indicates “non-storable”, a normal converting process is performed in step S108. For example, in the case of an image, transfer information with the image therein but without the identifier added thereto is transferred to the rendering unit 2.

In step S109, it is determined whether or not there is an unprocessed element. If there is an unprocessed element, the operation returns to step S101 so as to process the element. When there is no unprocessed element remaining, the converting process for the set of information to be output ends.

The process performed by the rendering unit 2 is the same as that described in the first specific example with reference to FIG. 5, and therefore, a description thereof will be omitted here. For example, in the above-described example of operation performed by the converting unit 1 shown in FIGS. 9A and 9B, if it is determined in step S132 that the data amount of the image is smaller than or equal to the threshold value, an image without an identifier is transferred in step S108. The rendering unit 2 receiving this transfer information performs a normal rendering process in step S113 in FIG. 5 so as to render the transferred image. In this case, a registration process and a searching process are not performed on the image management table 12, and the image is not stored into or read from the storage unit 3. The converting unit 1 determines that allowing the rendering unit 2 to perform a normal rendering process rather than to use the image management table 12 or the storage unit 3 allows for a shorter processing time, and therefore, a process according to the determination by the converting unit 1 is performed by the rendering unit 2.

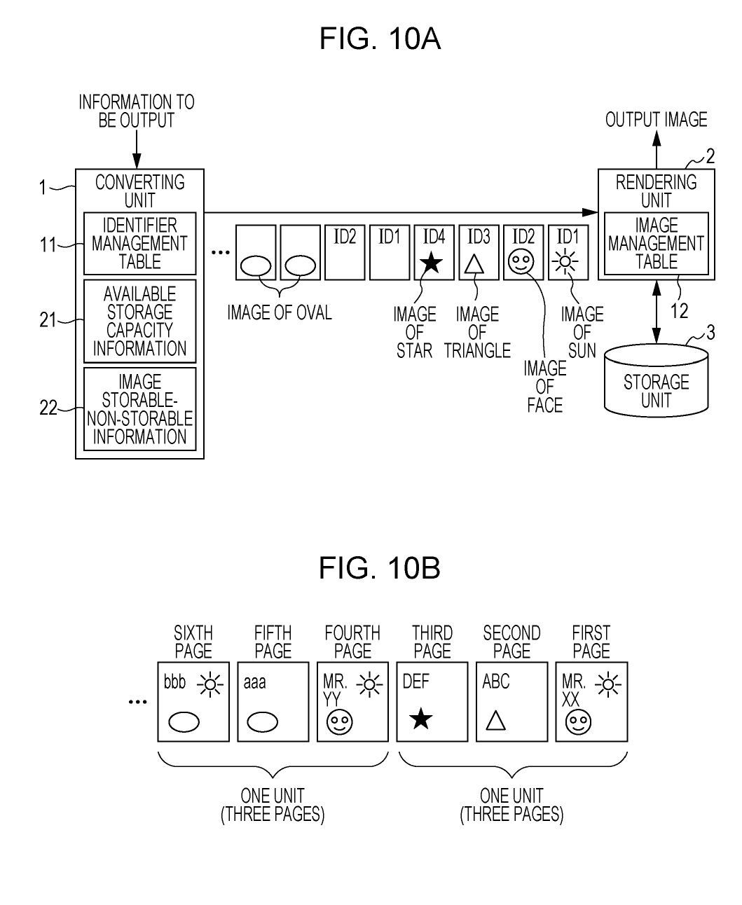

FIGS. 10A and 10B illustrate a fourth specific example of an image processing device according to an exemplary embodiment of the present invention. Given information to be output may sometimes be used repeatedly for every certain number of pages. In this case, it is assumed that an image to be used repeatedly is used on every first page. With regard to a subsequent new image to be used, it is assumed that the image may be used alone. Therefore, even if images to be used on every second page and onward are stored into the storage unit 3, the images may be not used for subsequent pages, possibly leading to a wasteful searching process performed by the rendering unit 2 on the image management table 12, waste of capacity of the storage unit 3, and so on.

In the fourth specific example, the number of pages as one unit is set. When the number of pages is smaller than or equal to the set number of pages, the process described in each of the above specific examples is performed, and when the number of pages exceeds the set number of pages, control is performed such that a new image excluding an image previously stored in the storage unit 3 is transferred by being included in transfer information, and the new image is not stored into the storage unit 3.

For example, FIG. 10B illustrates an example in which three pages are repeated as one unit. Although images of the sun and the face on the first page are repeatedly used, an image of a triangle on the second page and an image of a star on the third page are different from images of an oval on the fifth and sixth pages and are used in respective units.

In such an example, it is assumed that the number of pages as one unit is set to three pages. As shown in FIG. 10A, transfer information with the image of the sun on the first page included therein and an identifier ID1 added thereto is transferred to the rendering unit 2. Moreover, transfer information with the image of the face included therein and an identifier ID2 added thereto is transferred to the rendering unit 2. With regard to the image of the triangle on the second page and the image of the star on the third page, since these images are within the set number of pages, the images are included in transfer information and have respective identifiers ID3 and ID4 added thereto before being transferred to the rendering unit 2. With regard to these images, the converting unit 1 registers the identifiers therefor into the identifier management table 11, and the rendering unit 2 performs a storing process on the storage unit 3 and a registration process on the image management table 12. Even if these images appear only once, the images are stored into the storage unit 3 if they are within the set number of pages. If there is not enough available capacity in the storage unit 3 or if a condition for not storing the images into the storage unit 3 is satisfied, for example, the transfer information may sometimes be transferred with the images included therein but without the identifiers added thereto.

With regard to the image of the sun and the image of the face on the fourth page, since the identifiers therefor are registered in the identifier management table 11, transfer information with the identifiers added thereto but without the images included therein is transferred to the rendering unit 2. In this case, the rendering unit 2 acquires the addresses in the storage unit 3 and the information about the data amounts from the image management table 12 in accordance with the identifiers as described above and reads and uses the images from the storage unit 3.

With regard to the image of the oval on the fifth page, even though the image is a new image, the number of pages has exceeded the set number of pages. In this case, transfer information is transferred with the image of the oval included therein but without an identifier added thereto, and the rendering unit 2 does not register the image of the oval into the storage unit 3. With regard to the image of the oval on the sixth page, although the image is a second image of the oval, since the image is not registered in the identifier management table 11 when the image appeared on the fifth page and the number of pages has exceeded the set number of pages, transfer information is transferred with the image of the oval included therein but without an identifier added thereto.

By performing this control, transfer is omitted for images commonly used in the respective units.

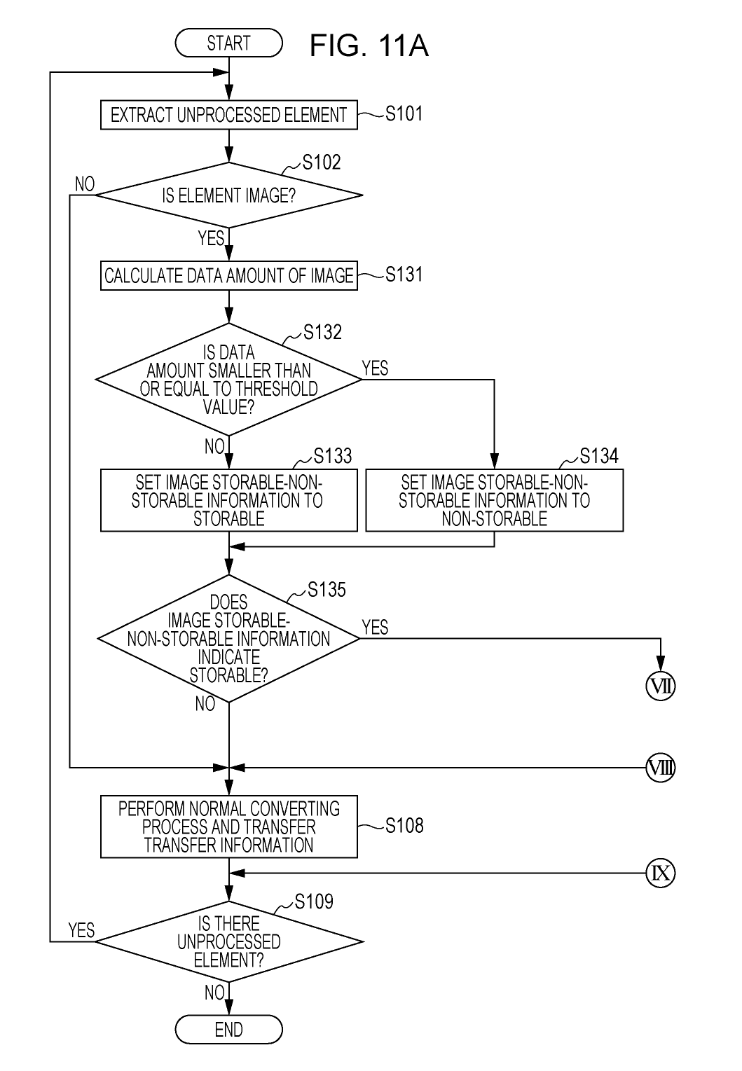

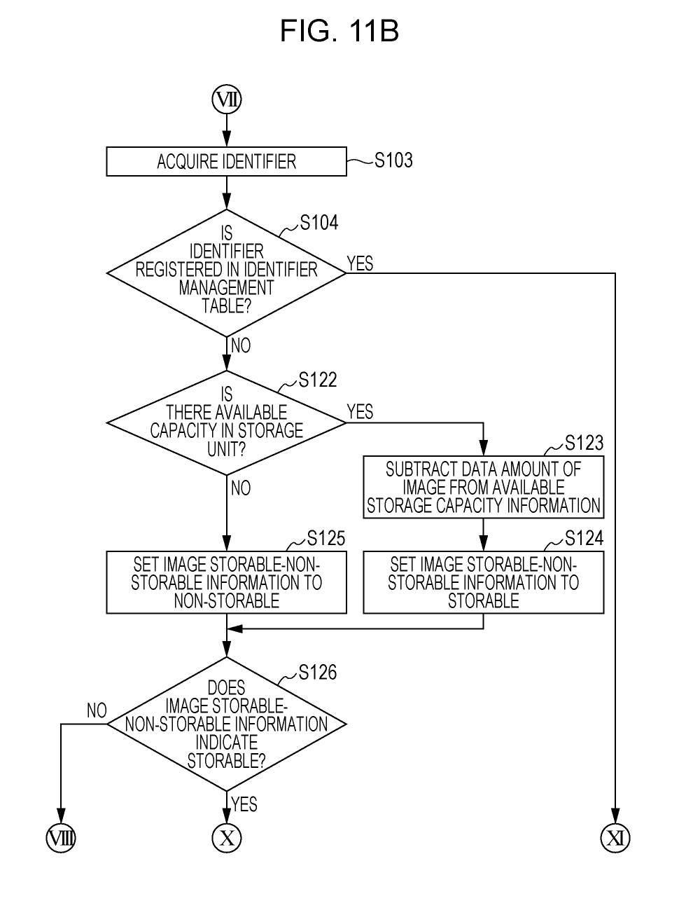

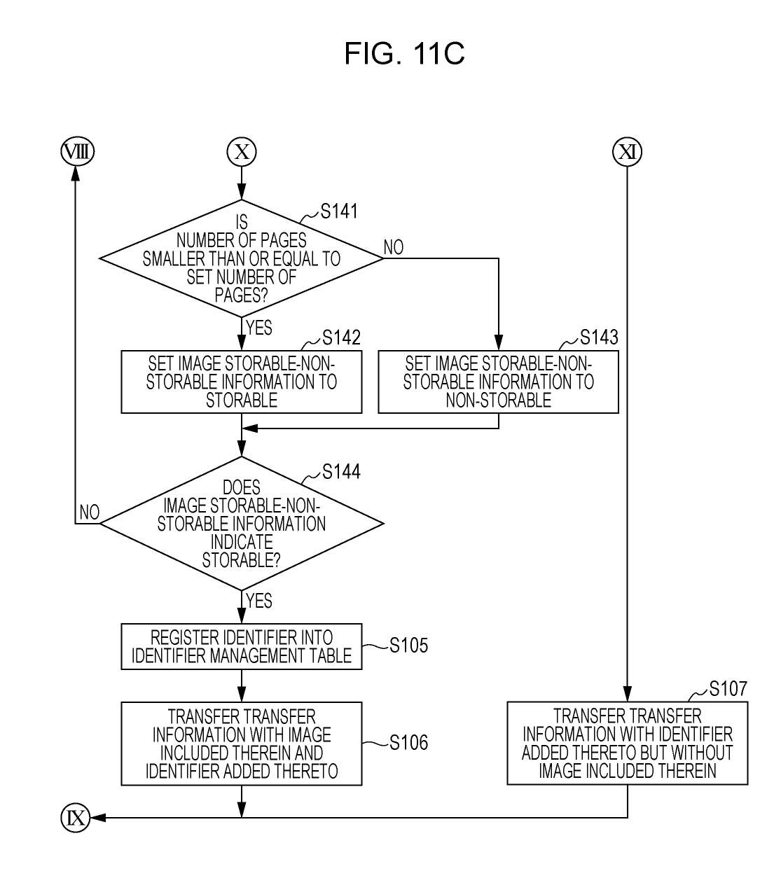

FIGS. 11A to 11C illustrate the flow of operation performed by the converting unit 1 in the fourth specific example of the image processing device according to the exemplary embodiment of the present invention. The following description relates to an example of operation in which the limitation of the number of pages is performed in addition to the functions of the first specific example, the second specific example, and the third specific example described above. With regard to the process described in each of the above specific examples, reference characters used in the description of the operation are directly used, and descriptions of redundant processes may sometimes be omitted. The number of pages may be set by various kinds of methods so long as it is set in advance. For example, the number of pages may be set by setting a fixed value, by being given together with information to be output, or by being commanded by an operator.

In step S101, an unprocessed element is extracted from information to be output. In step S102, it is determined whether or not the element is an image. If the element is an image, the data amount of the image is calculated in step S131. In step S132, it is determined whether the calculated data amount satisfies a condition for not storing the image into the storage unit 3. If the condition is satisfied, the operation proceeds to step S134 where the image storable-non-storable information 22 is set to “non-storable”. If the condition is not satisfied, the operation proceeds to step S133 where the image storable-non-storable information 22 is set to “storable”. In step S135, it is determined whether the image storable-non-storable information 22 indicates “storable” or “non-storable”. If “non-storable”, control is performed for not allowing the rendering unit 2 to perform a process using the storage unit 3. For example, in step S108, transfer information is generated by performing a normal converting process and is transferred to the rendering unit 2.

If it is determined in step S135 that the image storable-non-storable information 22 indicates “storable”, an identifier for the image is acquired in step S103, and it is determined in step S104 whether or not the identifier is registered in the identifier management table 11. If it is determined in step S104 that the identifier is registered in the identifier management table 11, the operation proceeds to step S107 where transfer information with the identifier added thereto but without the image included therein is transferred to the rendering unit 2.

If it is determined in step S104 that the identifier is not registered in the identifier management table 11, the operation proceeds to step S122 where it is determined whether or not there is available capacity in the storage unit 3 for storing the image by comparing the data amount of the image calculated in step S131 with the available storage capacity information 21. If there is available capacity, the data amount of the image calculated in step S121 is subtracted from the available storage capacity information 21 in step S123 so as to obtain new available storage capacity information 21. In step S124, the image storable-non-storable information 22 is set to “storable”. If there is no available capacity, the image storable-non-storable information 22 is set to “non-storable” in step S125. In step S126, it is determined whether the image storable-non-storable information 22 indicates “storable” or “non-storable”. If the image storable-non-storable information 22 indicates “non-storable”, a normal converting process is performed in step S108. For example, in the case of an image, transfer information with the image included therein but without the identifier added thereto is transferred to the rendering unit 2.

If the determination result obtained in step S126 indicates that the image storable-non-storable information 22 is “storable”, it is determined in step S141 whether or not the current number of pages is smaller than or equal to the preset number of pages. If the current number of pages is smaller than or equal to the preset number of pages, the image storable-non-storable information 22 is set to “storable” in step S142. If the current number of pages exceeds the preset number of pages, the image storable-non-storable information 22 is set to “non-storable” in step S143. In step S144, it is determined whether the image storable-non-storable information 22 indicates “storable” or “non-storable”. If the image storable-non-storable information 22 indicates “non-storable”, a normal converting process is performed in step S108. For example, in the case of an image, transfer information with the image included therein but without the identifier added thereto is transferred to the rendering unit 2. If it is determined in step S144 that the image storable-non-storable information 22 indicates “storable”, the identifier is registered into the identifier management table 11 in step S105. In step S106, the transfer information with the image included therein but without the identifier added thereto is transferred to the rendering unit 2.

In step S109, it is determined whether or not there is an unprocessed element. If there is an unprocessed element, the operation returns to step S101 so as to process the element. When there is no unprocessed element remaining, the converting process for the set of information to be output ends.

The process performed by the rendering unit 2 is the same as that described in the first specific example with reference to FIG. 5, and therefore, a description thereof will be omitted here. For example, in the above-described example of operation performed by the converting unit 1 shown in FIGS. 11A to 11C, if it is determined in step S141 that the current number of pages exceeds the preset number of pages, an image without an identifier is transferred in step S108. Therefore, a normal rendering process is performed in step S113 in FIG. 5 so as to render the transferred image. In this case, a registration process and a searching process are not performed on the image management table 12, and the image is not stored into or read from the storage unit 3. An image that appears when the current number of pages exceeds the preset number of pages may be transient. Thus, a problem caused by, for example, an increase in processing amount for a searching process when such an image uses the capacity of the storage unit 3 and is registered into the image management table 12 may be avoided. Such control is performed by the converting unit 1.

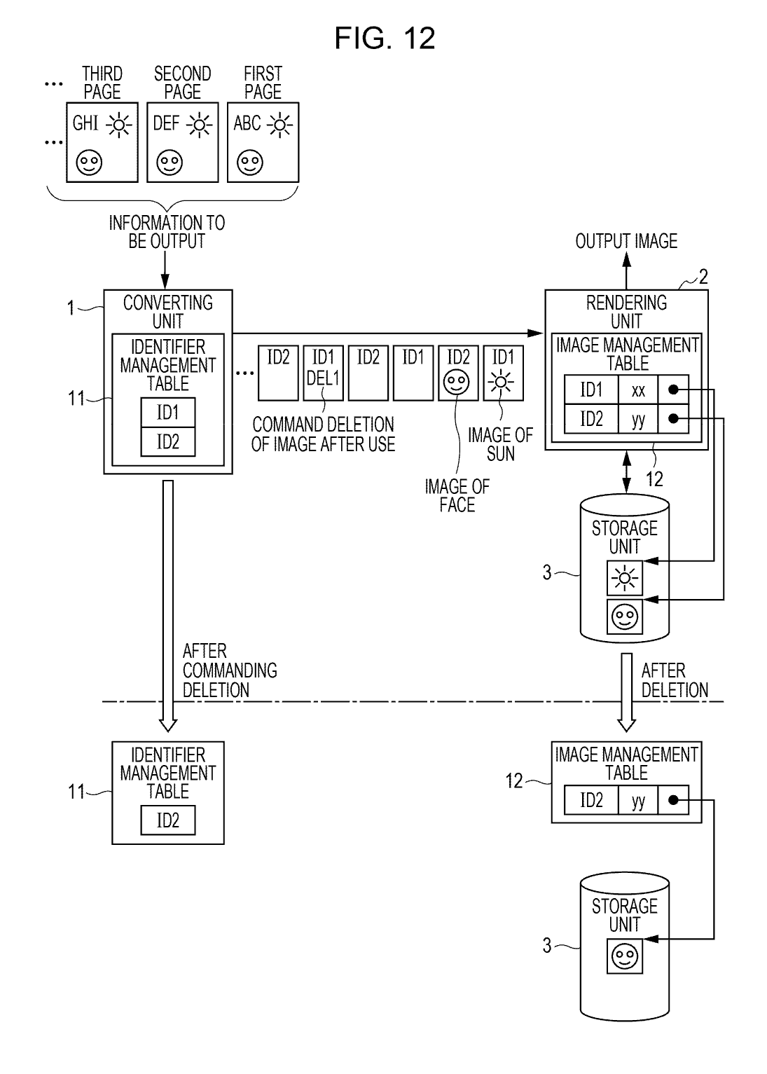

FIG. 12 illustrates a fifth specific example of an image processing device according to an exemplary embodiment of the present invention. Although an image to be stored into the storage unit 3 is added thereto in each of the above-described specific examples, the control performed by the converting unit 1 is not limited to this. Alternatively, a configuration that commands the rendering unit 2 to delete an image stored in the storage unit 3 is also permissible. For example, with regard to an image determined by the converting unit 1 to be no longer used hereinafter, transfer information with a deletion command added thereto is transferred to the rendering unit 2. Then, the rendering unit 2 receiving this transfer information deletes the image corresponding to the command from the storage unit 3. Thus, an available capacity is ensured even when the capacity of the storage unit 3 is scarce, and may be used for storing subsequent images. The deletion command may be of various kinds, such as deleting an image after it is used, deleting an image before it is used, and deleting all images stored in the storage unit 3.

In the example shown in FIG. 12, with regard to a first image of the sun and a subsequent image of a face, transfer information with the images included therein and identifiers added thereto is transferred, as described in the first specific example. In this case, the converting unit 1 registers an identifier ID1 for the image of the sun and an identifier ID2 for the image of the face into the identifier management table 11. Since the images are included in the transferred transfer information and have the identifiers added thereto, the rendering unit 2 stores the image of the sun and the image of the face into the storage unit 3 and registers the addresses and the data amounts thereof into the image management table 12 in correspondence with the identifiers.

With regard to a subsequent image of the sun and a subsequent image of the face, since these images are already registered in the identifier management table 11, transfer information with the identifiers added thereto but without the images included therein is transferred to the rendering unit 2. The rendering unit 2 reads the corresponding images from the storage unit 3 based on the identifiers added to the transferred transfer information and performs a rendering process.

With regard to a subsequent image of the sun, it is assumed that the converting unit 1 commands deletion of the image after it is used, and the image is shown as “DEL1”. In this case, the transfer information does not have the image included therein but has the corresponding identifier added thereto together with the command for deleting the image after it is used. The converting unit 1 transferring this transfer information deletes the identifier ID1 for the image of the sun from the identifier management table 11. The rendering unit 2 receiving this transfer information reads the image of the sun from the storage unit 3 based on the identifier ID1 added to the transfer information and performs a rendering process. Then, the rendering unit 2 deletes the image of the sun from the storage unit 3 and also deletes registration information of the identifier ID1 from the image management table 12. By deleting the image, an available capacity in the storage unit 3 increases from the state before the deletion and is used for storing a new image to be used thereafter.

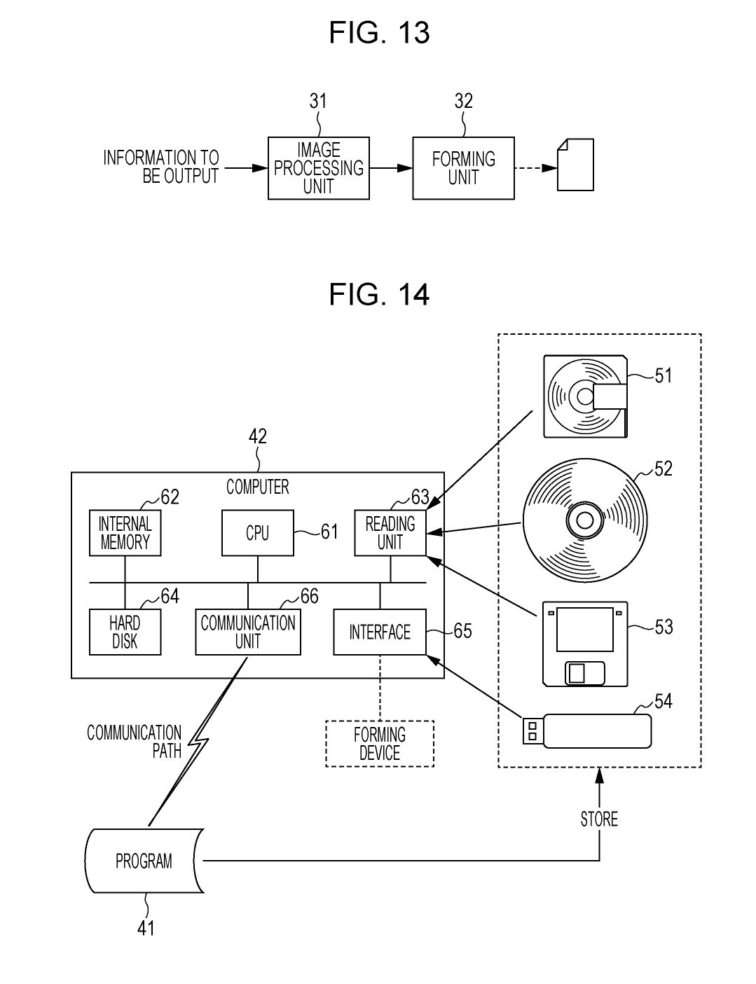

FIG. 13 illustrates the configuration of an image forming apparatus according to an exemplary embodiment of the present invention. In FIG. 13, reference numeral 31 denotes an image processing unit, and 32 denotes a forming unit. As a configuration example that uses the above-described image processing device according to an exemplary embodiment, an example of an image forming apparatus is shown here.

The image processing unit 31 corresponds to the above-described image processing device according to an exemplary embodiment. The image processing unit 31 receives information to be output and outputs a rendered output image. The forming unit 32 forms the output image rendered by the image processing unit 31 onto a medium such as paper.

In such an image forming apparatus, output images may be sent from the image processing unit 31 to the forming unit 32 such that the forming unit 32 successively forms images. If the image processing unit 31 takes too much time for processing and is not ready in time for image formation by the forming unit 32, the interval for the image formation by the forming unit 32 increases, resulting in lower efficiency of the overall system, as compared with a case where images are successively formed. With the above-described image processing device according to an exemplary embodiment of the present invention being used as the image processing unit 31, the data amount of transfer information transferred from the converting unit 1 to the rendering unit 2 decreases as compared with a case where an image is transferred every time, so that the processing efficiency of the image processing unit 31 may be improved as compared with a case where the above-described image processing device according to an exemplary embodiment of the present invention is not used, and the image forming efficiency may also be improved.

FIG. 14 illustrates a computer program, a storage medium having the computer program stored therein, and a computer when the functions of the converting unit 1 and the rendering unit 2 described in the image processing device according to an exemplary embodiment of the present invention are realized by the computer program. In FIG. 14, reference numeral 41 denotes a program, 42 denotes a computer, 51 denotes a magneto-optical disk, 52 denotes an optical disk, 53 denotes a magnetic disk, 54 denotes a memory, 61 denotes a central processing unit (CPU), 62 denotes an internal memory, 63 denotes a reading unit, 64 denotes a hard disk, 65 denotes an interface, and 66 denotes a communication unit.

The functions of the converting unit 1 and the rendering unit 2 described as the above-described image processing device according to an exemplary embodiment of the present invention may entirely or partially be realized by the program 41 executed by the computer 42. In that case, the program 41, data used by the program 41, and so on may be stored in a computer-readable storage medium. The storage medium is configured to induce a change in, for example, magnetic, optical, or electrical energy in the reading unit 63 equipped in a hardware source of the computer 42 in accordance with the descriptive content of the program 41 and transmit the descriptive content of the program 41 to the reading unit 63 based on the format of a corresponding signal. Examples of the storage medium include the magneto-optical disk 51, the optical disk 52 (including a compact disc (CD) and a digital versatile disc (DVD)), the magnetic disk 53, and the memory 54 (including an integrated-circuit (IC) card, a memory card, and a flash memory). These storage media are not limited to a portable type.

The program 41 is stored in any one of these storage media, and the storage medium is mounted to, for example, the reading unit 63 or the interface 65 of the computer 42. Then, the program 41 is read by the computer 42 and is stored into the internal memory 62 or the hard disk 64 (including a magnetic disk and a silicon disk). The CPU 61 then executes the program 41, whereby the functions of the converting unit 1 and the rendering unit 2 described as the above-described image processing device according to an exemplary embodiment of the present invention are entirely or partially realized. Alternatively, the program 41 may be transmitted to the computer 42 via a communication path, the computer 42 may receive the program 41 via the communication unit 66 and store the program 41 into the internal memory 62 or the hard disk 64, and the CPU 61 may execute the program 41. The storage unit 3 may be realized by, for example, the internal memory 62, the hard disk 64, or an external storage device connected via a communication path.

The computer 42 may additionally be connected to various devices via the interface 65. For example, the above-described image forming apparatus according to an exemplary embodiment of the present invention may be realized by connecting, to the computer 42, a forming device that forms an output image rendered by the function of the rendering unit 2 onto a medium. Alternatively, the computer 42 may be connected via the interface 65 to other various kinds of devices, such as a display device that provides various kinds of information to the user and an accepting device that accepts a command from the user.

The components do not have to operate in a single computer. For example, a computer that realizes the function of the converting unit 1 and a computer that realizes the function of the rendering unit 2 may be connected to each other via a physical communication path.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing device comprising:
a rendering unit that includes a storage unit that stores therein an image transferred with transfer information when the rendering unit receives the transfer information and renders a print image, the rendering unit rendering the print image while using the image stored in the storage unit; and
a controller that includes a converting unit that converts information to be output into the transfer information and transfers the transfer information to the rendering unit, the converting unit managing a storage status of the storage unit included in the rendering unit and controlling use of the storage unit by the rendering unit based on the transfer information.

2. The image processing device according to claim 1,
wherein the converting unit adds an identifier to the image when transferring the transfer information with the image included therein, and transfers the identifier without including the image therein for a subsequent redundant image, and
wherein when the rendering unit receives the image with the identifier added thereto, the rendering unit stores the image into the storage unit in correspondence with the identifier, and wherein when the rendering unit receives the identifier without the image included therein, the rendering unit performs a rendering process by using the image stored in the storage unit in correspondence with the identifier.

3. The image processing device according to claim 1,
wherein if the storage unit does not have enough capacity available for allowing the rendering unit to store the image therein, the converting unit transfers the transfer information with the image included therein.

4. The image processing device according to claim 2,
wherein if the storage unit does not have enough capacity available for allowing the rendering unit to store the image therein, the converting unit transfers the transfer information with the image included therein.

5. The image processing device according to claim 1,
wherein if the image satisfies a preset condition, the converting unit transfers the transfer information with the image included therein regardless of whether or not the image is stored in the storage unit.

6. The image processing device according to claim 2,
wherein if the image satisfies a preset condition, the converting unit transfers the transfer information with the image included therein regardless of whether or not the image is stored in the storage unit.

7. The image processing device according to claim 3,
wherein if the image satisfies a preset condition, the converting unit transfers the transfer information with the image included therein regardless of whether or not the image is stored in the storage unit.

8. The image processing device according to claim 1,
wherein the converting unit manages the storage unit to store a new appearing image if the number of pages including the new appearing image is smaller than or equal to a preset number of pages, and includes the new appearing image into the transfer information if the number of pages including the new appearing image exceeds the preset number of pages.

9. The image processing device according to claim 2,
wherein the converting unit manages the storage unit to store a new appearing image if the number of pages including the new appearing image is smaller than or equal to a preset number of pages, and includes the new appearing image into the transfer information if the number of pages including the new appearing image exceeds the preset number of pages.

10. The image processing device according to claim 3,
wherein the converting unit manages the storage unit to store a new appearing image if the number of pages including the new appearing image is smaller than or equal to a preset number of pages, and includes the new appearing image into the transfer information if the number of pages including the new appearing image exceeds the preset number of pages.

11. The image processing device according to claim 4,
wherein the converting unit manages the storage unit to store a new appearing image if the number of pages including the new appearing image is smaller than or equal to a preset number of pages, and includes the new appearing image into the transfer information if the number of pages including the new appearing image exceeds the preset number of pages.

12. The image processing device according to claim 5,
wherein the converting unit manages the storage unit to store a new appearing image if the number of pages including the new appearing image is smaller than or equal to a preset number of pages, and includes the new appearing image into the transfer information if the number of pages including the new appearing image exceeds the preset number of pages.

13. The image processing device according to claim 6,
wherein the converting unit manages the storage unit to store a new appearing image if the number of pages including the new appearing image is smaller than or equal to a preset number of pages, and includes the new appearing image into the transfer information if the number of pages including the new appearing image exceeds the preset number of pages.

14. The image processing device according to claim 7,
wherein the converting unit manages the storage unit to store a new appearing image if the number of pages including the new appearing image is smaller than or equal to a preset number of pages, and includes the new appearing image into the transfer information if the number of pages including the new appearing image exceeds the preset number of pages.

15. The image processing device according to claim 1,
wherein the transfer information transferred from the converting unit to the rendering unit includes a deletion command for deleting an image stored in the storage unit, and
wherein the rendering unit deletes, from the storage unit, the image corresponding to the deletion command based on the transfer information.

16. The image processing device according to claim 2,
wherein the transfer information transferred from the converting unit to the rendering unit includes a deletion command for deleting an image stored in the storage unit, and
wherein the rendering unit deletes, from the storage unit, the image corresponding to the deletion command based on the transfer information.

17. The image processing device according to claim 3,
wherein the transfer information transferred from the converting unit to the rendering unit includes a deletion command for deleting an image stored in the storage unit, and
wherein the rendering unit deletes, from the storage unit, the image corresponding to the deletion command based on the transfer information.

18. The image processing device according to claim 4,
wherein the transfer information transferred from the converting unit to the rendering unit includes a deletion command for deleting an image stored in the storage unit, and
wherein the rendering unit deletes, from the storage unit, the image corresponding to the deletion command based on the transfer information.

19. A non-transitory computer readable medium storing an image processing program causing a computer to execute functions, the functions comprising:
a rendering unit that stores an image transferred with transfer information into a storage unit when receiving the transfer information and rendering a print image, and that renders the print image while using the stored image; and
a converting unit that converts information to be output into the transfer information and transfers the transfer information to the rendering unit, the converting unit managing a storage status of the storage unit and controlling use of the storage unit by the rendering unit based on the transfer information.
